(19) United States
(12) Patent Application Publication
(10) Pub. No.: US 2026/0213028 A1
(43) Pub. Date: Jul. 23, 2026

(54) Nuclear fuel pellet with radially variable enrichment

(71) Applicant: FRAMATOME, COURBEVOIE (FR)

(72) Inventors: Julien DUMOND, Fürth (DE); Martin SCHNEIDER, CALUIRE ET CUIRE (FR); Yannick WRTAL, VILLEURBANNE (FR)

(21) Appl. No.: 19/137,685

(22) PCT Filed: Dec. 14, 2023
(86) PCT No.: PCT/EP2023/085795

§ 371 Date: Jun. 11, 2025

(30) Foreign Application Priority Data
Dec. 14, 2022 (FR) FR22 13354

(51) Int. Cl. G21C 3/04

(52) U.S. Cl. CPC G21C 3/048

(57) ABSTRACT

A nuclear fuel pellet with a radially variable enrichment is of symmetrical shape of revolution around a central axis and contains a fissile material. The pellet having concentric layers including a proximal layer, an intermediate layer, and a distal layer, in which the enrichment in fissile material within the pellet varies radially, the intermediate layer includes a high enrichment zone in which the enrichment is strictly greater than the enrichment in the proximal layer and/or the enrichment in the distal layer.

### CROSS-REFERENCE TO RELATED APPLICATIONS

This application is the U.S. National Phase of PCT Appl. No. PCT/EP2023/085795 filed Dec. 14, 2023, which claims priority to FR 22 13354, filed Dec. 14, 2022, the entire disclosures of which are incorporated by reference herein.

### TECHNICAL FIELD

The present disclosure relates to the field of nuclear fuel, and in particular to a nuclear fuel pellet intended to be integrated into a nuclear fuel rod.

### BACKGROUND

A core of a light water or heavy water nuclear reactor is generally formed of a plurality of nuclear fuel assemblies arranged side by side, each nuclear fuel assembly comprising a bundle of nuclear fuel rods, each nuclear fuel rod comprising a tubular sheath containing nuclear fuel, the sheath being sealed at each of its two ends by a plug.

The nuclear fuel is, for example, provided in the form of nuclear fuel pellets containing a fissile material, each pellet being generally cylindrical in shape, the pellets being stacked in the sheath.

During the combustion of a nuclear fuel pellet, there is a risk of deterioration of the pellet, and in particular a risk of fragmentation, relocation, and/or dispersion of the fuel (or FFRD for “Fuel Fragmentation Relocation and Dispersion” according to English terminology).

This risk is higher in the case of locally high combustion within the pellet or locally high temperature within the pellet.

### SUMMARY

One of the aims of the present disclosure is to propose a nuclear fuel pellet allowing to limit the risk of deterioration of the pellet during its use.

To this end, the present disclosure proposes a nuclear fuel pellet of symmetrical shape of revolution around a central axis and containing a fissile material, the pellet having concentric layers including a proximal layer, an intermediate layer, and a distal layer, in which the enrichment in fissile material within the pellet varies radially, and the intermediate layer comprises a high enrichment zone in which the enrichment is strictly higher than the enrichment in the proximal layer and/or the enrichment in the distal layer.

The radially variable enrichment in fissile material of the pellet allows the reactivity and combustion within the nuclear fuel pellet to be adjusted depending on the radius, in order to limit the risk of deterioration related to locally high combustion and/or locally high temperature.

In particular, higher enrichment in an intermediate layer than in a proximal layer allows energy equivalence to be preserved while limiting the temperature at the center of the pellet, which limits the risk of melting in an accidental situation.

Higher enrichment in an intermediate layer than in a distal layer allows energy equivalence to be preserved while limiting the risk of too high a combustion in the distal layer.

According to particular embodiments, the pellet comprises one or more of the following optional features, taken individually or according to any technically possible combination:
the enrichment increases with the radius in a zone of the intermediate layer adjacent to the proximal layer;
the increase in enrichment is continuous or discontinuous, and/or gradual;
the enrichment decreases with the radius in a zone of the intermediate layer adjacent to the distal layer;
the decrease in enrichment is continuous or discontinuous, and/or gradual;
the enrichment is maximum at an interface between the proximal layer and the intermediate layer;
the enrichment decreases from an interface between the proximal layer and the intermediate layer to an interface between the intermediate layer and the distal layer;
the decrease in enrichment is continuous or discontinuous, and/or gradual;
the enrichment presents a plateau of maximum enrichment in the intermediate layer;
the enrichment is constant in the intermediate layer;
the enrichment in the proximal layer is equal to or greater than 0.25% and/or equal to or less than 1.0% and/or the enrichment in the distal layer is equal to or greater than 0.25% and equal to or less than 1.0%;
the enrichment in the high enrichment zone is equal to or greater than 1.8% and/or equal to or less than 10.0%;
the intermediate layer represents a volumetric fraction of the pellet comprised between 60% and 94% and/or the proximal layer represents a volumetric fraction of the pellet comprised between 5% and 20% and/or the distal layer represents a volumetric fraction of the pellet comprised between 1% and 20%.

The present disclosure also relates to a nuclear fuel rod, comprising a tubular sheath containing pellets as defined above.

### BRIEF DESCRIPTION OF THE DRAWINGS

The present disclosure and its advantages will be better understood by reading the following description, given solely by way of example, and made with reference to the appended drawings, in which:

FIG. 1 is a schematic sectional view of a nuclear fuel rod comprising nuclear fuel pellets;

FIG. 2 is a schematic sectional view of a nuclear fuel pellet;

FIGS. 3 to 6 are graphs illustrating different enrichment profiles of a nuclear fuel pellet as a function of the radius;

FIG. 7 is a schematic sectional view of a nuclear fuel pellet according to another embodiment.

### DETAILED DESCRIPTION

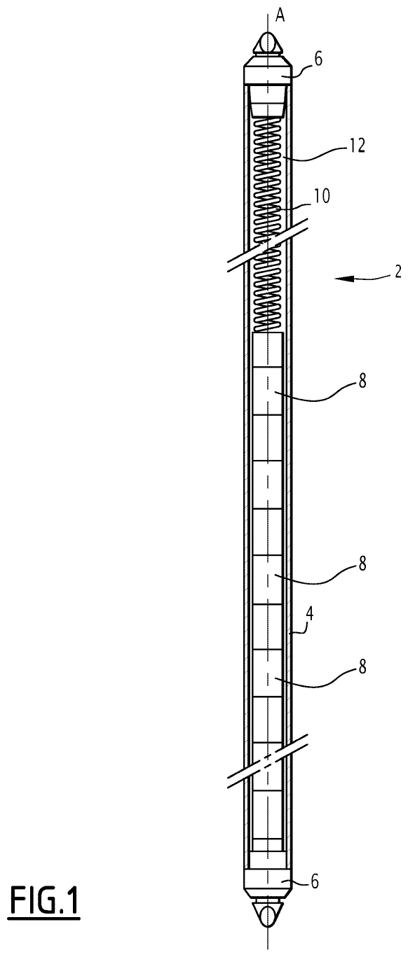

FIG. 1 illustrates a nuclear fuel rod 2 intended to be used in a light water reactor, in particular a pressurized water reactor (or PWR for “Pressurized Water Reactor”) or a boiling water reactor (or BWR for “Boiling Water Reactor”), a “VVER” type reactor, an “RBMK” type reactor, a heavy water reactor, for example of the “CANDU” type.

The nuclear fuel rod 2 is elongated according to a longitudinal axis A.

The nuclear fuel rod 2 comprises a sheath 4 containing nuclear fuel. The sheath 4 is tubular and extends according to the longitudinal axis A. The sheath 4 is sealed at each of its ends by a plug 6.

The nuclear fuel presents the form of a stack of nuclear fuel pellets 8 stacked axially inside the sheath 4, each pellet 8 containing fissile material. The stack of pellets 8 is also called a “fissile column”.

The nuclear fuel rod 2 comprises a spring 10 arranged inside the sheath 4, between the stack of pellets 8 and one of the plugs 6, to push the stack of pellets 8 toward the other plug 6. A void or plenum 12 is present between the stack of pellets 8 and the plug 6 on which the spring 10 rests.

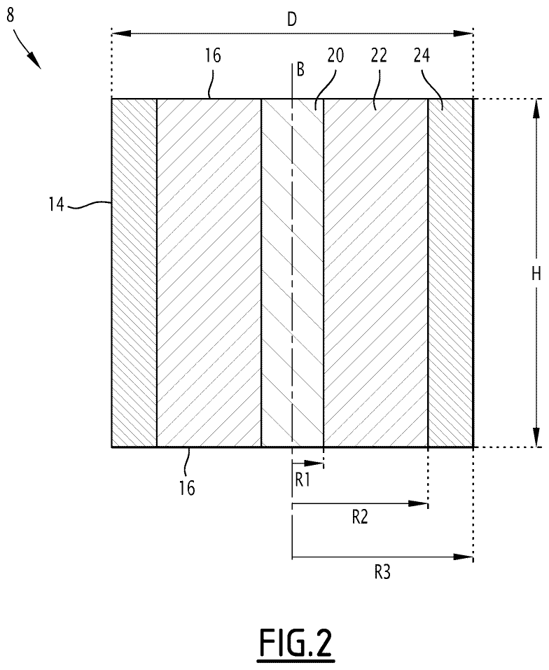

The pellets 8 are similar, and only one of the pellets 8 will be described in more detail later, notably with reference to FIG. 2.

As illustrated in FIG. 2, the pellet 8 presents a shape of revolution around a central axis B.

The pellet 8 preferably presents a general cylindrical shape with a circular cross-section centered on the central axis B.

The pellet 8 has a lateral surface 14 and two opposite end surfaces 16.

The lateral surface 14 extends according to the central axis B. The lateral surface 14 is cylindrical with a circular cross-section centered on the central axis B.

Each end surface 16 extends from an edge of the lateral surface 14 toward the central axis B.

Each end surface 16 is, for example, substantially flat and perpendicular to the central axis B.

The pellet 8 contains a fissile material, the fissile material being preferably uranium dioxide (UO₂).

The pellet 8 comprises, for example, a matrix made of a matrix material and the fissile material distributed in the matrix.

The pellet 8 has several concentric layers.

In particular, the pellet 8 has a proximal layer 20, an intermediate layer 22, and a distal layer 24, which are concentric.

The proximal layer 20 is the layer of the pellet 8 that is radially closest to the central axis B, and in particular that includes the central axis B. The proximal layer 20 is the radially innermost layer of the pellet 8.

The distal layer 24 is the layer of the pellet 8 that is radially farthest from the central axis B. The distal layer 24 is the radially outermost layer of the pellet 8. The distal layer 24 is the surface layer of the pellet 8.

The intermediate layer 22 is located radially between the proximal layer 20 and the distal layer 24.

The proximal layer 20 extends radially up to a first radius R1, the intermediate layer 22 extends radially between the first radius R1 and a second radius R2, and the distal layer 24 extends radially between the second radius R2 and a third radius R3.

The third radius R3 is the external radius of the pellet 8, that is, the radius of the lateral surface 14.

The pellet 8 presents, for example, a height H, taken according to the central axis B, comprised between 9 mm and 13 mm and/or an external diameter D comprised between 7 mm and 10 mm.

Each of the concentric layers of the pellet 8 presents a thickness taken radially.

The proximal layer 20 presents, for example, a thickness comprised between 700 μm and 2300 μm. The thickness of the proximal layer 20 is equal to the first radius R1.

The intermediate layer 22 presents a thickness comprised between 1.5 mm and 3.9 mm. The thickness of the intermediate layer is equal to the difference between the second radius R2 and the first radius R1.

The distal layer 24 presents, for example, a third thickness comprised between 17 μm and 528 μm. The thickness of the distal layer 24 is equal to the difference between the third radius R3 and the second radius R2.

The pellet 8 presents a concentration in fissile material or “enrichment”.

The enrichment of the pellet 8 varies radially, that is, as a function of the distance to the central axis B of the pellet 8.

Preferably, the enrichment of the pellet 8 varies only radially. The enrichment of the pellet 8 does not vary axially nor circumferentially. For a given radius, the enrichment is the same over the entire height of the pellet 8 and over the entire circumference of the pellet 8.

The intermediate layer 22 has a high enrichment zone in which the enrichment is strictly higher than in the proximal layer 20 and/or in the distal layer 24, preferably strictly higher than in the proximal layer 20 and in the distal layer 24.

The high enrichment zone extends, for example, over the entire radial extent of the intermediate layer 22, for example, if the enrichment is constant in the intermediate layer, or over a fraction of the radial extent of the intermediate layer 22, for example, if the enrichment varies within the intermediate layer 22.

Preferably, the enrichment present in the intermediate layer 22, and in particular in the high enrichment zone, has a maximum enrichment E_{MAX}.

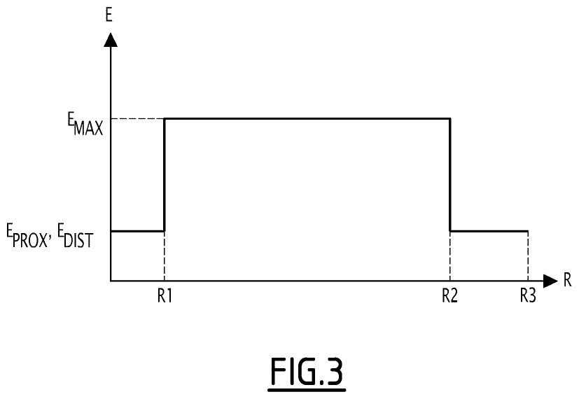

FIGS. 3 to 7 are graphs illustrating different examples of enrichment profiles E of the pellet 8 as a function of the radius R, that is, as a function of the distance to the central axis B of the pellet 8.

In the example of FIG. 3, the proximal layer 20 presents a constant proximal enrichment E_{PROX} in the proximal layer 20, a constant enrichment in the intermediate layer 22, and a constant distal enrichment E_{DIST} in the distal layer 24.

The enrichment in the intermediate layer 22 is strictly higher than the proximal enrichment E_{PROX} of the proximal layer 20 and the distal enrichment E_{DIST} of the distal layer 24.

The enrichment in the intermediate layer 22 corresponds to the maximum enrichment E_{MAX} of the pellet 8.

The intermediate layer 22 has a plateau of maximum enrichment E_{MAX} that extends over the entire extent of the intermediate layer 22.

The high enrichment zone of the intermediate layer 22 corresponds to the entire intermediate layer 22. The enrichment is high over the entire radial extent of the intermediate layer 22, that is, between the first radius R1 and the second radius R2.

The proximal enrichment E_{PROX} of the proximal layer 20 and the distal enrichment E_{DIST} of the distal layer 24 are, for example, equal.

Alternatively, the proximal enrichment E_{PROX} of the proximal layer 20 and the distal enrichment E_{DIST} of the distal layer 24 are different, one being strictly higher than the other.

In the example of FIG. 3, the enrichment profile presents a non-continuous jump at the interface between the proximal layer 20 and the intermediate layer 22, between the proximal enrichment E_{PROX} and the maximum enrichment E_{MAX}, and a non-continuous jump at the interface between the intermediate layer 22 and the distal layer 24, between the intermediate enrichment E_{MAX} and the distal enrichment E_{DIST}.

It is possible to provide a continuous and/or gradual variation in enrichment.

In particular, the intermediate layer 22 optionally comprises a transition zone with continuous and/or gradual variation in enrichment between the high enrichment zone and the proximal layer 20 and/or a transition zone with a continuous and/or gradual variation in enrichment between the high enrichment zone and the distal layer 24.

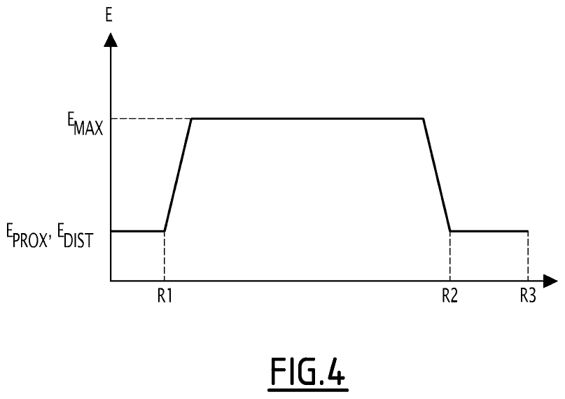

In one embodiment illustrated in FIG. 4, the enrichment increases continuously with the radius (that is, with the distance to the central axis B) in a zone of the intermediate layer 22 adjacent to the proximal layer 20, up to the high enrichment zone of the intermediate layer 22, for example, from the proximal enrichment E_{PROX} to the maximum enrichment E_{MAX}. The increase is continuous.

The increase is, for example, linear. Alternatively, the increase is non-linear.

Said zone of the intermediate layer 22 adjacent to the proximal layer 20 defines a transition zone between the proximal layer 20 and the high enrichment zone.

Alternatively, or optionally, as illustrated in FIG. 4, the enrichment decreases continuously with the radius in a zone of the intermediate layer 22 adjacent to the distal layer 24, for example, from the maximum enrichment E_{MAX} to the distal enrichment E_{DIST}. The decrease is continuous.

The decrease is, for example, linear. Alternatively, the decrease is non-linear.

Said zone of the intermediate layer 22 adjacent to the proximal layer 20 defines a transition zone and the high enrichment zone.

In a particular embodiment, within the intermediate layer 22, the enrichment increases continuously with the radius in the zone adjacent to the proximal layer, from the proximal enrichment E_{PROX} to the maximum enrichment E_{MAX}, then remains constant, then decreases continuously in the zone adjacent to the distal layer 24 until reaching the distal enrichment E_{DIST}.

As illustrated in FIG. 4, the enrichment profile presents an increasing portion from the proximal enrichment E_{PROX} to a plateau of maximum enrichment E_{MAX}, then a decreasing portion from the plateau of maximum enrichment E_{MAX} to the distal enrichment E_{DIST}.

The increasing portion is linear. It presents the shape of an ascending ramp with a constant slope. Alternatively, the increasing portion is non-linear. It presents a variable slope.

The decreasing portion is linear. It presents the shape of a descending ramp with a constant slope. Alternatively, the decreasing portion is non-linear. It has a variable slope. In one embodiment, the enrichment presents a gradual increase.

A gradual increase is, for example, achieved with one or more intermediate steps. A gradual increase is achieved, for example, in a continuous manner (with a ramp between two successive steps) and/or non-continuously (with a discontinuous jump between two successive steps).

In one embodiment, the enrichment presents a gradual decrease.

A gradual decrease is, for example, achieved with one or more intermediate steps. A gradual decrease is achieved, for example, in a continuous manner (with a ramp between two successive steps) and/or non-continuously (with a jump between two successive steps).

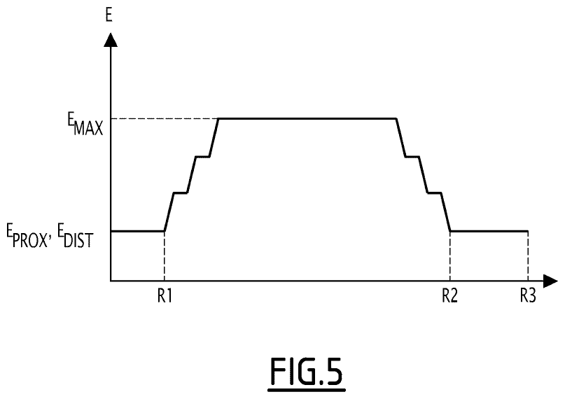

The enrichment profile illustrated in FIG. 5 differs from that of FIG. 4 in that the increase between the proximal enrichment E_{PROX} and the plateau of maximum enrichment E_{MAX} is gradual, here with two intermediate steps, and in that the decrease between the plateau of maximum enrichment E_{MAX} and the distal enrichment E_{DIST} is gradual, here with two intermediate steps.

The enrichment profile does not necessarily present a plateau of maximum enrichment in the intermediate layer 22.

The enrichment profile can increase in the intermediate layer 22 from the proximal enrichment E_{PROX} to the maximum enrichment E_{MAX} and/or decrease from the maximum enrichment E_{MAX} to the distal enrichment E_{DIST}, in presenting a high enrichment zone in which the enrichment is strictly higher than the proximal enrichment E_{PROX} and/or the distal enrichment E_{DIST}.

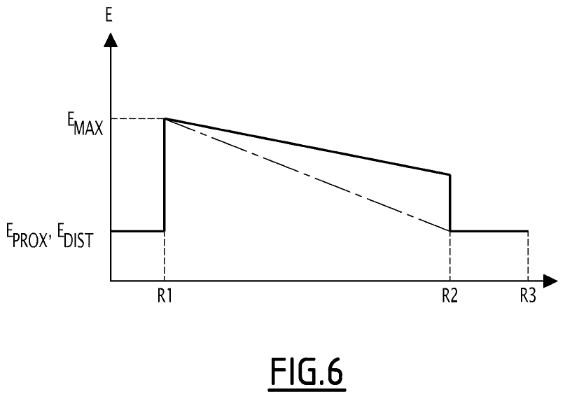

In one embodiment illustrated in FIG. 6, the enrichment is maximum at the interface between the proximal layer 20 and the intermediate layer 22, then decreases progressively to the interface between the intermediate layer 22 and the distal layer 24.

The enrichment decreases here continuously, and in particular, linearly, to the interface between the intermediate layer 22 and the distal layer 24. Alternatively, the enrichment decreases gradually to the interface between the intermediate layer 22 and the distal layer 24.

In one alternative, the maximum enrichment E_{MAX} is reached near the interface between the intermediate layer 22 and the distal layer 24, with a continuous or discontinuous and/or gradual variation between the proximal enrichment E_{PROX} and the maximum enrichment E_{MAX}, preferably over a small thickness, for example, a thickness comprised between 50 μm and 500 μm.

The enrichment at the interface between the intermediate layer 22 and the distal layer 24 is here strictly higher than the distal enrichment E_{DIST}. The enrichment presents a non-continuous jump at the interface between the intermediate layer 22 and the distal layer 24.

Alternatively, as illustrated in dashed lines in FIG. 6, the enrichment decreases in the intermediate layer 22 until reaching the distal enrichment E_{DIST} at the interface between the intermediate layer 22 and the distal layer 24.

The intermediate layer 22 presents in this case a high enrichment zone followed by a transition zone between the high enrichment zone and the distal layer 24.

The present disclosure is not limited to the embodiments described above and illustrated in FIGS. 3 to 6, other embodiments being conceivable, in particular combinations of the embodiments of FIGS. 3 to 6.

In one embodiment, the enrichment presents in the intermediate layer 22 a continuous and/or gradual increase between the proximal enrichment E_{PROX} and the maximum enrichment E_{MAX}, then a plateau at the maximum enrichment E_{MAX} up to the interface between the intermediate layer 22 and the distal layer 24 where the enrichment presents a discontinuous jump between the maximum enrichment E_{MAX} and the distal enrichment E_{DIST} (without continuous or gradual decrease between the maximum enrichment E_{MAX} and the distal enrichment E_{DIST}).

In one embodiment, the enrichment presents a discontinuous jump at the interface between the distal layer 20 and the intermediate layer 22 between the proximal enrichment E_{PROX} and the maximum enrichment E_{MAX}, then a plateau at the maximum enrichment E_{MAX} then a continuous and/or gradual decrease between the maximum enrichment E_{MAX} and the distal enrichment E_{DIST}.

Furthermore, it is possible to combine a continuous increase with a non-continuous decrease and a non-continuous increase with a continuous decrease.

In one embodiment in which the enrichment E presents a non-continuous gradual increase between the proximal enrichment E_{PROX} and the maximum enrichment E_{MAX} and a continuous decrease between the maximum enrichment E_{MAX} and the distal enrichment E_{DIST}.

In one embodiment, the enrichment E presents a continuous increase between the proximal enrichment E_{PROX} and the maximum enrichment E_{MAX} and a non-continuous gradual decrease between the maximum enrichment E_{MAX} and the distal enrichment E_{DIST}.

In one embodiment in which the enrichment presents a linear increase and a linear decrease, the absolute values of the slope of the linear increase and the slope of the gradual decrease are, for example, equal.

Alternatively, the absolute values of the slope of the linear increase and of the slope of the gradual decrease, are different.

In one embodiment in which the enrichment presents a continuous increase and a continuous decrease, the increase and decrease are linear. Alternatively, the increase is linear and the decrease non-linear, or the increase is non-linear, and the decrease is linear.

In one embodiment, and as illustrated in FIGS. 3 to 6, the proximal enrichment E_{PROX} and the distal enrichment E_{DIST} are substantially equal.

In this case, preferably, the proximal enrichment E_{PROX} and the distal enrichment E_{DIST} are equal to a minimum enrichment of the pellet 8.

Alternatively, the proximal enrichment E_{PROX} and the distal enrichment E_{DIST} are different.

In this case, preferably, the one from the proximal enrichment E_{PROX}, and the distal enrichment E_{DIST}, that is lower than the other is the minimum enrichment of the pellet 8.

In one embodiment, the proximal enrichment E_{PROX} is strictly higher than the distal enrichment E_{DIST}. In this case, preferably, the distal enrichment E_{DIST} is the minimum enrichment of the pellet 8.

In one embodiment, the proximal enrichment E_{PROX} is strictly lower than the distal enrichment E_{DIST}. In this case, preferably, the proximal enrichment E_{PROX} is the minimum enrichment of the pellet 8.

In general, the enrichment presents a discontinuous jump between the proximal layer 20 and the high enrichment zone of the intermediate layer 22 or a transition zone with a continuous and/or gradual increase between the proximal layer 20 and the high enrichment zone, and presents a discontinuous jump between the high enrichment zone of the intermediate layer 22 and the distal layer or transition zone with a continuous and/or gradual increase between the high enrichment zone and the distal layer 24.

Furthermore, the enrichment in the high enrichment zone is constant and presents a plateau of maximum enrichment E_{MAX} or varies radially, in which case the enrichment varies in the high enrichment zone, for example, continuously and/or gradually, forming, for example, one or more plateaus.

The radially variable enrichment within the pellet 8 allows the required amount of fissile material in the pellet 8 to be provided, while limiting the risk of degradation of the pellet 8, in particular the “FFRD” risk.

A higher enrichment in the intermediate layer 22 than in the proximal layer 20 allows the required amount of fissile material to be provided, while limiting the risk of reaching too high a temperature at the center of the pellet 8, particularly in accidental conditions.

A higher enrichment in the intermediate layer 22 than in the distal layer 24 allows the required amount of fissile material to be provided, while limiting the risk of too high combustion of the combustible material at the periphery of the pellet 8.

The enrichment of the pellet 8 is preferably adjusted so as to provide a required amount of fissile material contained in the pellet 8, and preferably to maintain energy equivalence between the pellet 8 and a reference pellet presenting a uniform reference enrichment E_{REF} and having substantially the same geometry, in particular having the same volume as the pellet 8.

Considering the example of the enrichment profile of FIG. 3, the following equation must be respected:

$${E}_{REF} = {E}_{PROX} \times ( {FV}_{PROX} ) + {E}_{MAX} \times ( {FV}_{INT} ) + {E}_{DIST} \times ( {FV}_{DIST} )$$

in which:
E_{REF} is the reference enrichment of the reference pellet;
E_{PROX} is the enrichment of the proximal layer 20;
E_{MAX} is the enrichment of the intermediate layer 22;
E_{DIST} is the enrichment of the distal layer 24;
FV_{PROX} is the volumetric fraction of the proximal layer 20, that is, the ratio of the volume of the proximal layer 20 to the volume of the pellet 8;
FV_{INT} is the volumetric fraction of the intermediate layer 22, that is, the ratio of the volume of the intermediate layer 22 to the volume of the pellet 8; and
FV_{DIST} is the volumetric fraction of the distal layer 24, that is, the ratio of the volume of the distal layer 24 to the volume of the pellet 8.

In a particular example in which E_{REF}=4%, E_{PROX}=E_{DIST}=0.3%, FV_{PROX}=10%, FV_{DIST}=5%, and FV_{INT}=85%, a maximum enrichment E_{MAX}=4.65% is obtained.

Preferably, the volumetric fraction of the proximal layer 20 is comprised between 5% and 20%.

Preferably, the volumetric fraction of the intermediate layer 22, in particular, of the high enrichment zone of the intermediate layer 22, is comprised between 60% and 94%.

Preferably, the volumetric fraction of the distal layer 24 is comprised between 1% and 20%.

Preferably, the enrichment in the proximal layer 20 is equal to or greater than 0.25% and/or equal to or less than 1.0%.

Preferably, the enrichment in the distal layer 24 is equal to or greater than 0.25% and/or equal to or less than 1.0%.

Preferably, the enrichment in the high enrichment zone of the intermediate layer 22 is equal to or greater than 1.8% and/or equal to or less than 10.0%.

Preferably, the ratio between the maximum enrichment E_{MAX} and the proximal enrichment E_{PROX} is, for example, comprised between 1.8 and 40.

Preferably, the ratio between the maximum enrichment E_{MAX} and the distal enrichment E_{DIST} is, for example, comprised between 1.8 and 40.

Compliance with the dimensions and/or proportions, taken individually or in combination, allows a pellet 8 containing an appropriate amount of fissile material to be obtained while limiting the risks of deterioration.

The reduction of the risk of degradation of the pellet 8 may eventually allow at least partially to overcome the geometric constraints of usual pellets, and in particular the presence of a chamfer at the junction between the lateral surface 14 and each end surface 16 and/or the presence of a depression at the center of each end surface 16.

As illustrated, in particular, in FIG. 2, the pellet 8 can be provided with a cylindrical shape, in particular, without a chamfer at the junction between the lateral surface 14 and each end surface 16 and with flat end surfaces 16.

This allows to simplify the manufacture of the pellet 8.

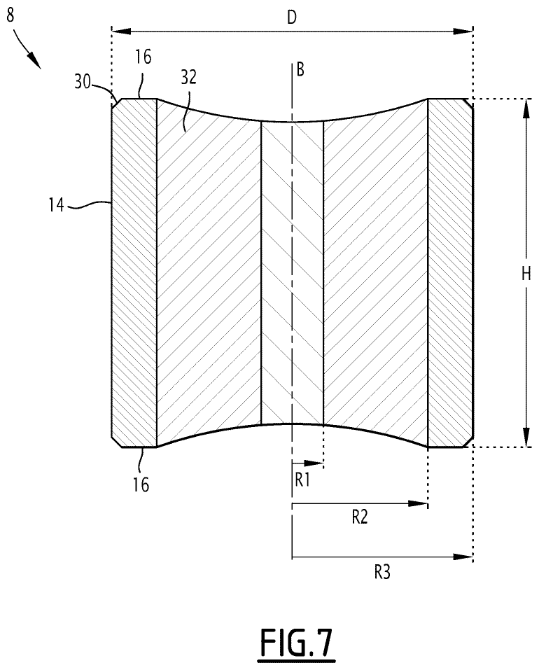

As illustrated in FIG. 7, the present disclosure can also be applied to a pellet of general cylindrical shape the geometry of which differs from that of FIG. 2 in that it comprises a chamfer 30 at the junction between the lateral surface 14 and each end surface 16 and/or a depression 32 at the center of each end surface 16.

A pellet 8 comprising a matrix and a fissile material contained in the matrix with radially varying enrichment (that is, a concentration in fissile material varying radially) is obtained, for example, by sintering.

In this case, the enrichment is, for example, constant in the proximal layer 20, constant in the intermediate layer 22, and/or constant in the distal layer 24, as, for example, in the example of FIG. 3.

Alternatively, a pellet 8 comprising a matrix and a fissile material contained in the matrix with radially varying enrichment is obtained, for example, by additive manufacturing (or 3D printing) from powders, including, for example, a first powder constituted of the fissile material and a second powder constituted of a matrix material, the pellet 8 being additively manufactured by varying the proportions between the first powder and the second powder.

The pellet 8 is manufactured, for example, by successive concentric manufacturing layers by varying the proportions between the first powder and the second powder between the manufacturing layers.

Each of the concentric layers of the pellet 8 (proximal layer 20, intermediate layer 22, and distal layer 24) is formed of several superimposed manufacturing layers.

Each possible variation in enrichment within the intermediate layer 22, continuous or not, is obtained by varying the proportions between the first powder and the second powder between the manufacturing layers of the intermediate layer 22.

Additive manufacturing is carried out, for example, by one or more of the following methods: selective laser sintering (or SLS from the English “Selective Laser Sintering”), electron beam melting (or EBM from the English “Electron Beam Melting”), direct metal laser sintering (or DMSL from the English “Direct Metal Laser Sintering”), direct energy deposition (or “Direct Energy Deposition” according to English terminology), and spark plasma sintering (or SPS from the English “Spark Plasma Sintering”).

In the above, the pellet is considered before irradiation of the pellet. The pellet is considered at the end of the manufacture of the pellet, in particular, before integration of the pellet into a nuclear fuel rod and/or before use of the pellet in a nuclear reactor. The enrichment values are expressed in mass percentages.

What is claimed is:

1.-14. (canceled)

15. A nuclear fuel pellet of symmetrical shape of revolution around a central axis and containing a fissile material, the pellet comprising:
concentric layers including:
a proximal layer,
an intermediate layer, and
a distal layer,
an enrichment in fissile material within the pellet varying radially,
the intermediate layer comprising a high enrichment zone having an enrichment strictly greater than an enrichment in the proximal layer and/or strictly greater than an enrichment in the distal layer.

16. The pellet according to claim 15, wherein the enrichment in fissile material within the pellet increases with the radius in a zone of the intermediate layer adjacent to the proximal layer.

17. The pellet according to claim 16, wherein the increase in the enrichment in the zone of the intermediate layer is continuous or discontinuous, and/or gradual.

18. The pellet according to claim 15, wherein the enrichment in fissile material within the pellet decreases with the radius in a zone of the intermediate layer adjacent to the distal layer.

19. The pellet according to claim 18, wherein the decrease in enrichment in the zone of the intermediate layer continuous or discontinuous, and/or gradual.

20. The pellet according to claim 15, wherein the enrichment in fissile material within the pellet is maximum at an interface between the proximal layer and the intermediate layer.

21. The pellet according to claim 15, wherein the enrichment in fissile material within the pellet decreases from an interface between the proximal layer and the intermediate layer to an interface between the intermediate layer and the distal layer.

22. The pellet according to claim 21, wherein the decrease in enrichment from the interface between the proximal layer and the intermediate layer to the interface between the intermediate layer and the distal layer is continuous or discontinuous, and/or gradual.

23. The pellet according to claim 15, wherein the enrichment in fissile material within the pellet presents a plateau of maximum enrichment in the intermediate layer.

24. The pellet according to claim 15, wherein an enrichment in the intermediate layer is constant.

25. The pellet according to claim 15, wherein the enrichment in the proximal layer is, in mass percentage, equal to or greater than 0.25% and/or equal to or less than 1.0%; and/or
the enrichment in the distal layer is equal to or greater than 0.25% and equal to or less than 1.0%.

26. The pellet according to claim 15, wherein the enrichment in the high enrichment zone is, in mass percentage, equal to or greater than 1.8% and/or equal to or less than 10.0%.

27. The pellet according to claim 15, wherein the intermediate layer represents a volumetric fraction of the pellet comprised between 60% and 94%; and/or
the proximal layer represents a volumetric fraction of the pellet comprised between 5% and 20%;
and/or the distal layer represents a volumetric fraction of the pellet comprised between 1% and 20%.

28. A nuclear fuel rod, comprising a tubular sheath containing pellets, each of the pellets being the pellet according to claim 15.
